(19) United States
(12) Patent Application Publication
(10) Pub. No.: US 2005/0205644 A1
(43) Pub. Date: Sep. 22, 2005

(54) Method and device for holding a metallic component to be connected, especially a gas turbine blade

(76) Inventor: Reinhold Meier, Dorfen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/504,065

(22) PCT Filed: Feb. 11, 2003
(86) PCT No.: PCT/DE03/00392

§ 371 Date: May 26, 2005

(30) Foreign Application Priority Data
Feb. 11, 2002 (DE) 102 06 447.4

(51) Int. Cl. B23K 5/22; B23K 37/00

(52) U.S. Cl. 228/47.1; 228/212

(57) ABSTRACT

A method for holding a metallic component of a gas turbine, which is to be connected, includes providing a metallic component having a surface and at least one machining or joining surface, providing a case having a cutout, which has an inner surface, for receiving the component, positioning the component in the case in such a manner that its surface is surrounded, at a distance, by the inner surface of the case, so as to form a closed volume and so that its machining or joining surface does not face the volume, filling the volume with a foamable material, foaming the material and cooling so as to form a dimensionally stable foam, structure. An apparatus for holding the metallic component and a method for connecting the metallic component to a further component are also provided.

### BACKGROUND AND SUMMARY OF THE INVENTION

This invention relates to a method and an apparatus for holding a metallic component which is to be connected, in particular a main blade or vane part for a gas turbine, and to a method for connecting a metallic component, in particular a main blade or vane part for a gas turbine, to a further component.

It is generally desirable that metallic components or surfaces thereof should not be damaged or adversely affected in any way when they are being connected to further components. For example, if a main blade or vane part of a stationary gas turbine or of an aircraft engine is being connected to a blade or vane root, a blade or vane cover strip or a carrier of a compressor or turbine rotor by means of a suitable method, for example welding, the shape and surface of the main blade or vane part should not be adversely affected in terms of aerodynamic or strength aspects. Such damage may occur during the connecting operation, for example when the main blade or vane part is being held by means of clamping jaws, as a result of the punctiform introduction of forces, and is particularly critical if relatively high levels of forces are introduced.

A problem on which the invention is based is that of providing a method for holding a metallic component of the generic type described in the introduction, in which the component is treated as gently as possible, in terms of its shape and surface, during a machining operation. Furthermore, it is intended to provide a corresponding holding apparatus. Furthermore, it is intended to provide a method for connecting a component held in this way to a further component.

A solution to the problem mentioned is provided by the methods and the apparatus claimed.

One advantage of the method according to the invention for holding a metallic component which is to be connected is that the component is held areally, rather than in punctiform fashion, and consequently there is no punctiform loading of its surface. The foam structure, which is dimensionally stable after cooling to ambient temperature, nestles virtually completely against the surface of the component to be connected and represents play-free, rigid, positively locking coupling to the component directly or between the case, the foam structure and the component. The surface or outer skin of the foam is so homogenous and compact that there is no damage to the surface of the component to be connected. Otherwise, the foam structure is cellular and has a porosity. For the component to be connected to further components by welding or other suitable joining processes, therefore, it is possible for considerable forces to be introduced via the component, for example for pressing the joining surfaces together, without the surface of the component being damaged, the shape of the component being changed or additional large-volume formations having to be provided on the component for introduction of forces and then having to be removed again following the joining operation.

The term machining or joining surface is to be understood as meaning that the method is employed not only if the metallic component which is to be held is connected to a further component by means of its joining surface, for example by welding, but also if the metallic component to be held, in a subsequent step, is machined at a machining surface, such as for example in the case of a main blade or vane part, which is almost in its finished form, for example has been forged or cast, for a gas turbine but whose end face is still to undergo finish-machining in a further step, for example by milling.

The foamable material usually comprises a foamable base material, e.g. a plastic or a metal, and a blowing agent, which forms a gas when heated. In the case of a metal as base material, the heating is carried out to a foaming temperature which at least corresponds to the melting point of the foamable metal and is below the melting point of the component material.

Depending on the component material, its surface may previously have been provided with a preferably metallic protective layer, such as an electroplated Ni layer, in order to provide the component surface with optimum protection from any surface attacks during the heating or foaming. The final step is always that of cooling to a temperature which is below the melting point or foaming temperature, preferably to room temperature, so as to form a dimensionally stable, porous foam structure with a compact outer skin.

The method is suitable for a component of a gas turbine, such as a main blade or vane part, since these main blade or vane parts, which are generally in the form of forged or cast components, have to be connected, substantially in their finished form, to further components, such as for example a blade or vane root, a blade or vane cover strip or a compressor or turbine carrier, or have to undergo finish-machining, for example by milling at their end face. Consequently, the form or surface of main blade or vane parts of this type must not be subjected to punctiform damage during the joining or machining operation and should be largely in the finished form.

The case may be of two-part or multipart form, in which case the individual parts of the case, after the component has been positioned and the foamable material has been received, are fixed together in a suitable way, for example by bolts or the like. The case consists, for example, of a sufficiently strong and rigid, metallic material, such as for example steel.

A releasable spacer element, preferably also made from steel, can be provided in the parting join between the parts of the case, in order to vary the volume in the case, so as to compensate for any shrinkage of the foam during cooling. The spacer element can be removed after cooling. Then, the parts of the case are fixed together, directly abutting one another, so as to reduce the volume around the component, and any shrinkage is compensated for, producing a rigid coupling between case, foam structure and component.

In addition to the base material, such as for example Al, Mg, Cu, brass, bronze or polystyrene, polyurethane (Ps, PUR), the foamable material always contains a blowing agent, such as for example titanium hydride, which when heated forms a gas and is required to form the final cellular foam structure from the base material.

Depending on the strengths and moduli of elasticity required in the subsequent joining operation, the foamable material used may be a plastic, such as for example polystyrene or polyurethane (PS or PUR), or a metal, such as for example Al or Mg or Ni or Fe or an alloy of these elements, individually in combination, in order to produce the foam structure. The strength and the modulus of elasticity of the foam structure which holds the component is dependent not only on the base material but also on the pore structure and generally rises approximately linearly with the apparent density. The parameters used for foaming of said base materials are matched to the particular application in a manner with which the person skilled in the art will be familiar. The surface or outer skin of the foam structure is closed, compact and not too rough, in order to protect the surface of the component.

If the base material of the foamable material is a metal, the foaming temperature is at least in the region of its melting point and is always below the melting point of the component material. A metallic foam structure has the advantage over a plastic foam structure of a higher compressive strength. The risk of caking on the component surface is generally lower when foaming a metal-containing foamable material than with foamable plastics.

Particularly in the case of a metal as base material for the foamable material, the foamable material may be provided in dimensionally stable form as at least one semifinished product, preferably by sintering of the material with a suitable blowing agent in powder form. The semifinished product may be formed with locally different ratios between base material and blowing agent, so that a foam structure with locally different porosities or densities is formed after the foaming operation.

The more base material is locally present in the semifinished product compared to blowing agent, the higher the density after the foaming step, and consequently the lower the porosity of the foam structure. Since the compressive strength of the foam structure is approximately proportional to its density, it is possible to produce foam structures with variable compressive strengths. The foam structure which holds the component may have a lower porosity and therefore a higher density and a greater compressive strength at locations of the component which are subject to high forces during the further machining than at other locations.

For a foam structure with a high density, the semifinished product has to contain a large proportion of, for example, metallic base material compared to the blowing agent. As the person skilled in the art will understand, the density of the foam structure can also be controlled by means of the ratio of the volume of the semifinished product to the closed volume for the foamable material in the case. A greater degree of play when the closed volume is being filled with the semifinished product leads to a greater porosity and therefore a lower density and a lower compressive strength. The semifinished product may be formed or cut from a large-area metal sheet in a manner which is matched to the shape and size of the closed volume. For a closed volume, it is possible to combine a plurality of semifinished products with different ratios of base material to blowing agent, so that it is possible to produce a locally different porous and therefore dense foam structure.

During the positioning step, the machining or joining surface does not face the closed volume and can be received in a correspondingly shaped cutout in the case and/or can be positioned so as to project out of the case, so that it is not covered by the foam structure, but rather protrudes from the foam structure and if appropriate from the case, in order for a subsequent machining step to be carried out, for example in a welding or milling machine.

The contact region, adjacent to the machining or joining surface, between the component and the case may be sealed with a soft metal, such as copper or lead, in ring or strip form prior to the foaming operation, in order to compensate for shape or dimension differences between the component and the case in the contact region.

The component which is held in the foam structure may, in a final step, with the case or alternatively after the case has been removed, be mounted directly with the foam structure, in a machine for further machining.

The positioning of the component in the case may be carried out using a positioning means that interacts with the surface of the component, such as a threaded pin, in such a manner that the component is positioned without play in the case. Furthermore, the component may be provided with an attachment, by means of which the component is positioned in a positively locking manner in the case, preferably using a separate fixing means, such as a bolt.

The component provided may be a main blade or vane part, which includes a stacking axis, a blade or vane tip and two opposite blade or vane edges, for a gas turbine. The opposite blade or vane edges may make contact with the case during the positioning step, so as to form two closed volumes, in which case the steps of filling, foaming and cooling, in one configuration, can be carried out for just one of the two volumes, while in the other volume it is possible to provide positioning means, e.g. threaded pins, which interact with the surface of the component and onto which the component is pressed following the foaming operation.

The main blade or vane part, for example after it has been cast or forged, may be provided such that it has at least one pin which projects coaxially with respect to its stacking axis from its main blade or vane tip and/or its main blade or vane root beyond the main blade or vane part. The pin may be formed with a circular cross section which is flattened in parts, in order, during positioning of the main blade or vane part in the case or following the formation of the foam structure during positioning of the main blade or vane part in a machining apparatus or machine, to prevent twisting about the stacking axis.

During the positioning step, the pin can be received in a correspondingly shaped recess in the case, so that the pin projects out of the foam structure which is formed and can be used for positioning during further machining of the main blade or vane part.

In one configuration, the method may comprise the further step of mounting the component held in the foam structure, with or without case, in a machining apparatus or a machine. In the case of a main blade or vane part, the method may comprise the further steps of mounting the main blade or vane part, held in the foam structure, with or without case in a machining apparatus or a machine, and positioning the main blade or vane part by means of the projecting pin.

In the method for connecting a metallic component to a further component, the second component generally also consists of metal, and in the case of a gas turbine component, generally of a Ti or Ni or Co or Fe alloy. Any weld beads or small-volume, optional attachments which may occur during the joining operation on one of the components and which simplify positioning in the case can, in a subsequent step, be locally remachined or removed, for example by a material-removing process.

The holding apparatus for a metallic component which is to be connected is generally mounted for further machining in a machine, e.g. a welding or milling machine or a robot. The heating device for heating the foamable material may be designed in a suitable way for the particular application, for example by induction or by gas.

Further configurations of the methods and the apparatus are described.

In the text which follows, the invention is explained in more detail on the basis of exemplary embodiments and with reference to drawings.

### BRIEF DESCRIPTION OF THE DRAWINGS

FIG. 1 shows a sectional, perspective illustration of a holding apparatus according to the invention with a component which is held in accordance with the method according to the invention;

FIG. 2 shows a sectional, perspective illustration of an exemplary embodiment of a holding apparatus according to the invention, in which the component is connected to a further component;

FIG. 3 shows a perspective illustration of two components which have been connected in accordance with one exemplary embodiment of the method according to the invention and of one component which is held in an exemplary embodiment of a holding apparatus according to the invention and is yet to be connected; and

FIG. 4 shows an illustration corresponding to FIG. 3 of a further exemplary embodiment of the method according to the invention and a further exemplary embodiment of the holding apparatus according to the invention.

### DETAILED DESCRIPTION OF THE INVENTION

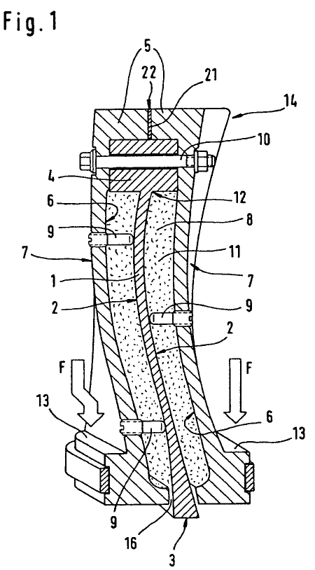

FIG. 1 shows a sectional, perspective illustration of a metallic component 1 which is held, using the method for holding a metallic component, in a corresponding holding apparatus denoted overall by 14. In the present configuration of the method, the metallic component is a main blade or vane part 1 made from a titanium alloy which is used, for example, for a compressor of a gas turbine. The main blade or vane part 1 has an outer surface 2 and a joining surface 3, which is connected to a joining surface of a further component (not shown in FIG. 1). In the present configuration, the main blade or vane part 1 additionally has an attachment 4, by means of which the main blade or vane part 1 is fixed for accurate positioning in the holding apparatus 14.

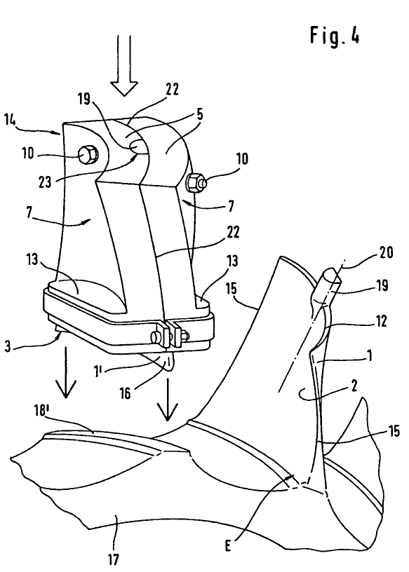

As an alternative, the attachment 4 may also be dispensed with or designed as a flattened pin 19 as illustrated in FIG. 4. The pin 19 runs coaxially with respect to the stacking axis 20 of the main blade or vane part 1. The main blade or vane part 1 has the pin 19 as a result of its production process, for example by forging. Therefore, the pin 19 is not provided as an additional means for carrying out the method according to the invention. The pin 19 running coaxially to the stacking axis 20 can be used for accurate positioning of the main blade or vane part 1 in the case 5 and also for positioning of the main blade or vane part 1 relative to a further component, such as a rotor carrier, to which the main blade or vane part 1 is to be connected.

In the present configuration, the holding apparatus 14 comprises a two-part case 5 made from steel, which has a cutout with an inner surface 6. Along a parting join 22 of the two parts of the case 5 there is a spacer element 21 which is removed following the cooling which follows the heating and foaming steps. The two parts of the case 5 are then connected directly abutting one another, in order to compensate for any shrinkage of the foam during cooling.

The main blade or vane part 1 is positioned in such a way in the cutout of the case 5 that its joining surface 3 projects out of the case 5 and its surface 2 is substantially surrounded, at a distance, by the inner surface 6 of the case 5, so as to form an outwardly closed volume 8. The case 5 is in contact with the main blade or vane part 1 only in a blade region 16 which adjoins the joining surface 3 and the attachment 4 or the pin 19 for more accurate positioning.

In the present configuration of the method, the foamable material 11 is in dimensionally stable form as a semifinished product. The shape and size of the two semifinished products which form the foamable material 11 are such that they virtually completely fill up the closed volume 8 between the surface 2 of the main blade or vane part 1 and the inner surface 6 of the case 5. In order not to influence the positioning of the main blade or vane part 1 in the case 5, the semifinished products 11 are introduced with a certain amount of play.

Positioning pins 9 which make contact with the surface 2 of the main blade or vane part 1 and can be fixed in the case 5, for example by a screw thread, are used to position the main blade or vane part 1 in the holding apparatus 14 clearly and without any play. Furthermore, the main blade or vane part 1 may optionally be unambiguously fixed to the case 5 at its attachment 4 by means of a bolt 10.

After the main blade or vane part 1 has been positioned and the foamable material 11 has been added, in the present case in the form of two sintered semifinished products formed from Al powder and a suitable blowing agent, the case 5 is closed in such a way that the volume 8 forms a closed volume, i.e. even in the contact region 16, which is to be sealed in a suitable way, for example using a strip or ring of a soft metal, such as Cu.

Then, the foamable material 11 which is present in the volume 8 is heated to the foaming temperature, which approximately corresponds to the melting point of Al. In the process, the blowing agent forms a gas which is responsible for foaming the partially melted Al. After cooling to room temperature, a dimensionally stable foam is formed, ensuring a positively locking, rigid connection between main blade or vane part 1 and case 5.

At an outer surface, the case 5 has a projection 13 on each of its two parts, at which the holding apparatus 14 can be fixed in a suitable machine, such as for example a welding machine or a robot. As illustrated by the arrows F, it is also possible, for example, for a force for connecting the main blade or vane part 1 to a further component (not shown in FIG. 1) to be introduced via the projection 13.

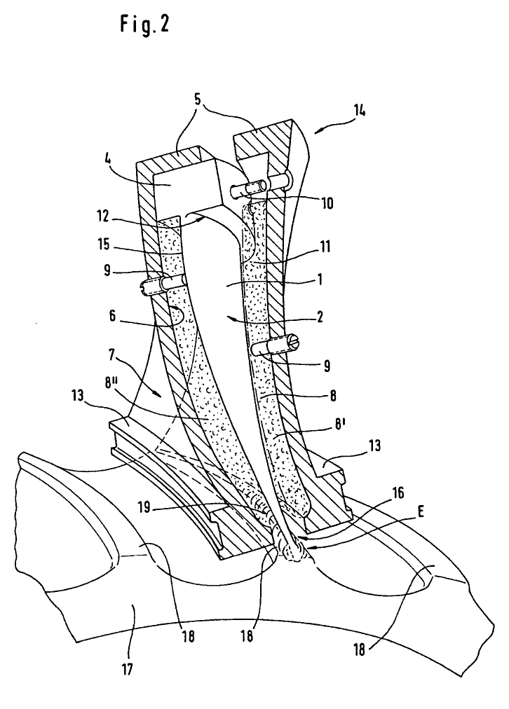

FIG. 2 shows a sectional, perspective illustration of a main blade or vane part 1 which is held in a holding apparatus 14 and is connected to a further component in accordance with an exemplary embodiment of the method according to the invention for connecting two components. In FIG. 2, the main blade or vane part 1, which is held in the manner described above, is not illustrated in sectional form, and it is possible to recognize one of the two blade or vane edges 15.

In the present exemplary embodiment, the main blade or vane part 1 is connected to a rotor carrier 17 in order to form a compressor rotor of a gas turbine. The rotor carrier 17 consists of a titanium alloy and, at its circumferential surface, has a multiplicity of joining surfaces 18 which are equidistantly spaced apart from one another and are each connected to a main blade or vane part 1 using the method according to the invention.

In the present configuration of the method, the main blade or vane part 1 which is held in the holding apparatus 14 as described above is connected to the carrier 17 by induction welding. For this purpose, the joining surfaces 3 and 18, respectively, of the main blade part 1 and the rotor carrier 17 are positioned substantially flush with and at a short distance from one another, are heated by means of an inductor (not shown), which circumferentially surrounds the joining plane E, and are then moved together. In the process, just a small weld bead 19 is formed, and this is ultimately removed by local remachining. The purely optional attachment 4 of the main blade part 1 is likewise removed after the connecting operation, and the blade tip 12 of the main blade part 1 is locally remachined.

This connecting operation is repeated with the required number of main blade parts 1 at the further joining surfaces 18 of the rotor carrier 17, so that ultimately an integrally bladed rotor with a large number of substantially radially extending main blade parts 1 is formed. The rotor can be used in a compressor of a gas turbine. Alternatively, it is possible to produce a turbine rotor of a gas turbine in a corresponding way, in which case the components to be connected may always also consist of different materials.

The main blade part 1 shown in FIG. 2, which has a blade tip 12 and two opposite blade edges 15, may alternatively be positioned in such a way in the case 5 that the opposite blade edges 15 make contact with the case 5, so as to form two closed volumes 8′, 8″. In this configuration, the steps of filling, foaming and cooling can be carried out for just one of the two volumes 8′, with positioning means 9, which interact with the surface 2 of the component 1, and, unlike in the situation illustrated in FIG. 2, no foamable material 11 being provided in the other volume 8″.

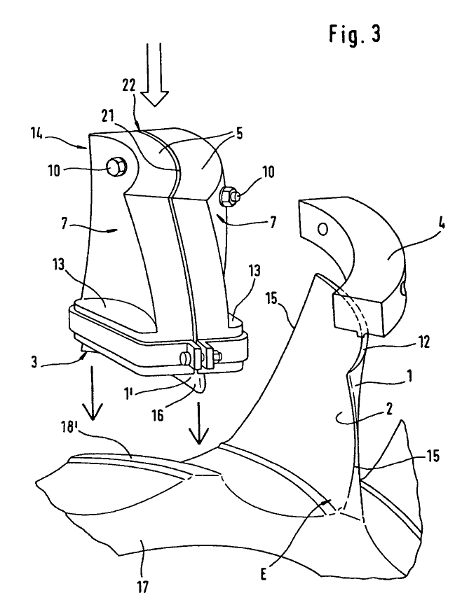

FIG. 3 shows a perspective illustration of a main blade part 1 which is connected to a rotor carrier 17 and from which the weld bead 19 and the attachment 4 have already been removed. A further main blade part 1′, which is held in a holding apparatus 14 and is then connected to the carrier 17, is positioned at a further joining surface 18′ of the carrier 17. A spacer element 21 is provided between the two parts of the case 5. After cooling to form the foam, the spacer element 21 can be removed, in order to compensate for any shrinkage of the foam. Moving the two parts of the case 5 together during the subsequent connection of these parts reduces the volume 8 so as to compensate for the shrinkage. The spacer element 21 may also remain in the parting join 22 between the two parts of the case 5 during the joining operation.

In general terms, first of all, all the main blade parts 1, 1′ are connected to the carrier 17, and then any remachining at weld beads 19 or the like is carried out.

In an alternative method, the main blade part 1 can be connected to the carrier 17 by means of linear friction welding. On account of the rigid connection between the case 5 and the main blade part 1 to be connected on account of the dimensionally stable foam structure, relatively great forces can be transmitted when the joining surfaces 3, 18 are being pressed together during the oscillation via the main blade part 1, which is virtually in its finished form. To simplify positioning in the case 5, in this method too the main blade part 1 may have an attachment 4 or a pin 19 running coaxially with respect to the stacking axis 20 of the main blade part 1.

FIG. 4 shows a pin 19 of this type, which has a cross section in the form of a flattened circle, thereby preventing twisting about the stacking axis 20. The pin 19 extends away from the main blade part 1 from the blade tip 12. This pin 19, which lies in the stacking axis 20 of the main blade part 1 and projects out of the foam structure, facilitates the positioning of the main blade part 1 during a subsequent connection operation, for example by welding, to a further component, such as a rotor carrier 17, which is defined, inter alia, by its axial axis, its diameter or its length.

With the case 5 shown in FIG. 4, no spacer element 21 is provided along the parting join 22. The pin 19 is positioned in a cutout in the case 5 and therefore projects out of the foam structure formed in the volume 8. For the heating and foaming operations, the parting join 22 between the parts of the case 5 and therefore also in the region of the projecting pin 19 has to be sealed. Depending on the wall thickness of the case 5 and the length of the pin 19, the latter may project out of the case 5.

1-37. (canceled)

38. A method for holding a metallic component which is to be connected, comprising:
providing a metallic component having a first surface and at least one machining or Joining second surface,
providing a case having a cutout, which has an inner surface, for receiving the component,
positioning the component in the case in such a manner that its first surface is surrounded, at a distance, by the inner surface of the case, so as to form a closed volume and so that said at least one machining or joining second surface does not face the volume,
filing the volume with a foamable material,
foaming the material, and
cooling so as to form a dimensionally stable foam structure.

39. The method as claimed in claim 38, wherein the component provided is made from a Ti, Ni, Co, or Fe alloy.

40. The method as claimed in claim 38, wherein the case provided is a two-part or multipart case, the parts of which are fixed together by screw connection or clamping after the positioning step.

41. The method as claimed in claim 40, and further comprising providing at least one spacer element in a parting join of the parts of the case in order to change the volume.

42. The method as claimed in claim 38, wherein the first surface of the component is positioned at an equidistant spacing from the inner surface of the case.

43. The method as claimed in claim 38, wherein the machining or joining second surface, during positioning the component in the case, is received in a correspondingly shaped cutout in the case.

44. The method as claimed in claim 43, wherein the machining or joining second surface is positioned so as to project out of the case.

45. The method as claimed in claim 44, wherein a contact region, adjacent to the machining or joining second surface, between the component and the case is sealed with a soft metal, such as copper or lead, prior to the foaming operation.

46. The method as claimed in claim 38, wherein positioning the component in the case is performed using a positioning means which interacts with the first surface of the component.

47. The method as claimed in claim 38, wherein the component has an attachment, by which the component is positioned in the case.

48. The method as claimed in claim 47, and further comprising using a separate fixing element to position the component.

49. The method as claimed in claim 38, wherein the foamable material is provided with a plastic or a metal as base material, and a suitable blowing agent.

50. The method as claimed in claim 49, wherein the foamable material is provided with polyurethane as base material.

51. The method as claimed in claim 49, wherein the foamable material is provided with at least one of Al, Mg, Ni, Fe, Cu, brass, bronze, an alloy of Al, an alloy of Mg, an alloy of Ni, an alloy of Fe, and an alloy of Cu as base material.

52. The method as claimed in claim 38, wherein the foamable material is provided in powder form.

53. The method as claimed in claim 38, wherein the foamable material is provided in dimensionally stable form as at least one semifinished product.

54. The method as claimed in claim 53, wherein the semifinished product is sintered.

55. The method as claimed in claim 53, wherein the semifinished product is designed with locally different ratios between base material and blowing agent.

56. The method as claimed in claim 38, and further comprising coating the component with a protective layer before positioning the component in the case.

57. The method as claimed in claim 56, wherein the protective layer is metallic.

58. The method as claimed in claim 56, wherein the protective layer is an electroplated Ni layer.

59. The method as claimed in claim 38, wherein the foamable material is provided with a metal as base material and is foamed by heating to a foaming temperature which corresponds at least to its melting point.

60. The method as claimed in claim 38, wherein the foamable material is provided with plastic as a base material and is foamed using a chemical or physical blowing method.

61. The method as claimed in claim 59, wherein heating is provided by induction, by gas, or in a furnace.

62. The method as claimed in claim 38, wherein the component is a main blade or vane part, which includes a stacking axis, a blade or vane tip and two opposite blade or vane edges, for a gas turbine.

63. The method as claimed in claim 62, wherein the opposite blade or vane edges make contact with the case while positioning the component in the case so as to form two closed volumes.

64. The method as claimed in claim 63, wherein filling, foaming and cooling are carried out for just one of the two volumes, while at least one positioning element which interacts with the first surface of the component is provided in the other of the two volumes.

65. The method as claimed in claim 62, wherein the main blade or vane part has at least one pin which projects, coaxially with respect to its stacking axis, from the blade or vane tip beyond the main blade or vane part.

66. The method as claimed in claim 65, wherein the pin is designed with a circular cross section which is flattened in parts.

67. The method as claimed in claim 65, wherein the pin, while positioning the component in the case, is received in a correspondingly shaped cutout in the case.

68. The method as claimed in claim 38, and further comprising mounting the component, which is held in the foam structure, with or without the case, in a machining apparatus or a machine.

69. The method as claimed in claim 65, and further comprising mounting the main blade or vane part, which is held in the foam structure, with or without the case, in a machining apparatus or a machine, and positioning the main blade or vane part by means of the at least one pin.

70. A method for connecting a metallic component to a further component, comprising:
holding a metallic first component using the method as claimed in claim 1,
providing a second component having at least one joining surface,
positioning the joining surface of the first component with respect to the joining surface of the second component, and
connecting the components by heating the joining surfaces and bringing them into contact with one another.

71. The method as claimed in claim 70, wherein connecting the components is performed by welding.

72. The method as claimed in claim 70, wherein the first and second components are connected by friction-welding in such a manner that a welding temperature is reached by pressing the joining surfaces together and, at the same time, imparting an oscillating relative movement to the components in a joining plane.

73. The method as claimed in claim 70, wherein the first and second components are connected by induction welding by heating the joining surfaces using an inductor and then bringing the joining surfaces into contact with one another.

74. The method as claimed in claim 70, wherein the first component is a main blade or vane part, and the second component is a blade or vane root or a blade or vane cover strip or a rotor carrier of a gas turbine having a multiplicity of circumferentially arranged joining surfaces.

75. The method as claimed in claim 74, wherein the method is repeated a number of times which corresponds to a number of joining surfaces on the second component, using a corresponding number of main blade or vane parts.

76. A holding apparatus for a metallic component which is to be connected, comprising:
a case having a cutout, which has an inner surface, for receiving a metallic component having a first surface and a machining or joining second surface, and
a foamable material, containing a metal as base material, in order to form a dimensionally stable foam structure which surrounds the first surface of the component but not its machining or joining second surface, and
a heating device for heating the foamable material to a foaming temperature which at least corresponds to its melting point.

77. The holding apparatus as claimed in claim 76, wherein the case is a two-part or multipart case, parts of which can be fixed to one another by screw connection or clamping.

78. The holding apparatus as claimed in claim 77, and further comprising at least one releasable spacer element in a parting join of the case.

79. The holding apparatus as claimed in claim 76, wherein the case has at least one shoulder on its outer surface for at least one of fixing in a machining apparatus or a machine and introduction of forces into a joining plane during a welding operation.

80. The holding apparatus as claimed in claim 76, wherein the foam structure has a locally differing density.
